(19) United States
(12) Patent Application Publication
(10) Pub. No.: US 2005/0046177 A1
(43) Pub. Date: Mar. 3, 2005

(54) Corrosion resistant barrier consisting of a UV light cured anti-corrosive basecoat and thermoplastic topcoat

(76) Inventors: Richard Chmiel, Houston, TX (US); Joseph A. Depoti, Carbondale, PA (US); John D. Neukirchen, Kirkland, WA (US)

Correspondence Address: David L. Garrison, Suite 3300, 2001 Sixth Avenue, Seattle, WA, 98121-2522, US

(21) Appl. No.: 10/934,017

(22) Filed: Sep. 2, 2004

Related U.S. Application Data
(60) Provisional application No. 60/499,447, filed on Sep. 2, 2003.

(51) Int. Cl. C08K 5/34; F16L 55/00

(52) U.S. Cl. 285/55; 427/558; 427/402; 428/626; 285/288.1

(57) ABSTRACT

A protective surface, and the article protected is described in which the surface is formed as a UV initiated basecoat over which a thermoplastic top coat is applied. The surface is first cleaned, then the UV initiated basecoat applied as a liquid to a thickness of 2 to 25 mils. UV light initiates polymerization and then the topcoat of a thermoplastic formulation is applied, preferably by flame spraying. The protective surface is particularly useful on pipeline joints.

### TECHNICAL FIELD

### Background of the Invention

A common problem experienced throughout industry is the protection of valuable structures and equipment from corrosive environments such as aggressive chemicals, abrasion and/or atmospheric weathering. Such structures are primarily constructed from steel or concrete and the most common method of protection is the application of a liquid protective coating. Depending upon the exposure environment and type of surface, a coating may be formulated from a variety of base resins. Examples are the use of epoxy novolacs and vinyl esters for chemical tank linings and polyamide epoxies and urethanes for atmospheric corrosion protection.

Though it is not the intent of this submittal to comment on the overall performance capability of these materials, they do have several common requirements within their formulation that in many cases prove to be problematic. First is the use of a catalytic agent or catalyst that is mixed with the base resin in order to create a chemical reaction between the two materials thereby causing the composition to harden. The second is the use of solvents or thinning agents in order to create the proper application viscosity. Depending upon the environmental conditions, the number of coats required, ease of application, and curing/setting time prior to introduction into service, these materials can be too slow, too expensive, or otherwise impractical for certain performance and/or time critical applications.

Other coating technologies such as fast setting 100% solids epoxies and urethanes address some of the above mentioned problems but are limited by pot life, application methods, or by nature of their chemistry or function fail to meet service performance requirements.

Applicable Technology:

Given the ongoing advancements in manufacturing processes throughout industry, the need for more advanced coating methods and technology is growing rapidly. In order to answer this requirement, a number of new and innovative methods and materials are being introduced. One recently recognized technology or method involves the use of specialized high intensity light or better known as UV curing. The principle of UV curing is based upon the initiation of a chemical polymerization inside a liquid coating by using direct UV irradiation to create a cross-linked solid coating. The method incorporates the introduction of a photoinitiator into the coating formulation, whereby controlled exposure to a concentrated UV light initiates an almost instantaneous chain reaction. The finished properties of a UV cured coating such as hardness, abrasion resistance, chemical resistance, and adhesive properties are formulated into the initial composition of the coating. The type and amount of UV initiator required to cross-link or cure the coating composition is matched with the intensity, dose, and spectral output of the UV light source/lamp. Though this technology is becoming widely accepted, it is important to note that it has been primarily limited to OEM/plant application onto smaller parts where the coated part is passed under or by the light via production conveyor. The coating is generally applied in a single thin finished coat of approximately 0.5 to 1 mil. The primary advantage of UV cure technology is that upon exposure to the UV light, the coating is instantly cured and immediately ready for handling. Examples are the production curing of coatings on soda cans and similar packaging, printing inks, and adhesives. Another highly effective form of coating is the use of thermoplastic and thermosetting powder coatings. Formulated from polyethylene, polypropylene, solid epoxy resin, etc., these materials produce a highly functional protective coating. Much larger in market application than UV cured materials, these materials are also generally limited to OEM/plant application. The most widely used method of application is to heat the part in an industrial oven to the melt temperature of the powder, apply the powder via dry flocking or dipping, and placing the coated part back into the oven for post melting/flowing. Another use of similar plastic technology is to pre-melt the polymer and extrude it onto a continuous part like wire or cable where it functions primarily as an insulating cover. A lesser known method of applying thermoplastic powder is via flame spray. The flame spray method allows for application onto larger parts or allows for a method of application outside the plant environment. In general, the application consists of blowing the thermoplastic powder through a propane and air generated flame whereby the powder is melted within the flame and deposited onto the surface in a uniform film. However, the application requires a similar pre-heating of the part to the near melt temperature of the thermoplastic in order to facilitate bond of the applied powder. In some cases a primer can be employed to act as the bonding site for the thermoplastic topcoat where pre-heat temperatures can be greatly reduced. However, these primers are formulated using heat stable epoxies or similar resins that require the addition of a catalytic agent and viscosity reducing solvents or thinning agents. Applied as a liquid film, these primers require a given amount of time to form their functional properties before the thermoplastic topcoat can be applied. Depending upon environmental conditions, formulation, and type of surface, the curing or setting time required for the primer can be longer than what is practically allowable for a given application.

Prior to describing the present invention, it is necessary to address some of the problems this invention is intended to overcome. Existing and newly constructed steel and concrete surfaces are frequently exposed to active corrosive and erosive environments. When protecting or rehabilitating such surfaces against corrosion and erosion several important issues must be addressed. First, an important distinction must be made between the application of a protective coating system in a controlled shop or plant environment onto newly manufactured, clean surfaces and the application of a protective coating system that is applied in a field environment. It is the purpose of this submittal to direct its subject matter at the effects, conditions, and successful application of a highly effective apparatus in the form of a protective coating system that is applied in the field or otherwise outside a controlled plant environment which combines the desireable attributes of prior coating systems. Field applied protective coating systems are subject to a wide variety of environmental effects. Temperature, humidity, airborne and other environmental contamination, etc all can have a profound effect on the overall performance capability of the applied coating system. A field applied coating system must be formulated or designed to obtain its required performance properties within a defined range of differing and changing environmental conditions. As discussed above, exposure to environmental conditions that exceed or occur before the coating system has cured, can greatly limit or destroy its performance capability. Second, the application ease or difficulty of the system must be considered. Given the possible environmental conditions, a field-applied protective coating system must be of proper design so that it can be successfully applied with uniform predictable results. In many cases, specialized application equipment and/or extraordinary environmental controls are employed. Coating systems that are subjected to chemically active and/or corrosive environments are attacked on both a massive level and microscopic level in a much more severe mariner than those exposed to more simple atmospheric exposure conditions. Therefore the complexity of the coating system grows in relation to the environment or condition it is exposed to. In some cases, highly specialized coatings, application procedures, and equipment are employed. Further, the importance of achieving a complete and uniform cure of the coating system grows in relation to the exposed/service condition. In many specialized applications, the requirement for a long term, high performance coating system is complicated by the added requirement for rapid installation. Rapid installation can be defined as a method that facilitates the complete installation of the protective coating system whereupon the installed protective coating system achieves its designed performance properties in a short or limited, predetermined timeframe. A few examples of applications that have this type of requirement are: the protection of pipeline joints on an offshore pipeline installation, the coating of the splash zone on a marine structure, maintenance shut downs in plants such as paper mills and power plants, and emergency repairs to critical operating structures and equipment.

### SUMMARY OF INVENTION

The invention described in this submittal allows for the rapid installation of a highly functional and effective protective coating system that can be applied in a wide range of environmental conditions. Designed initially for field application and subsequent long-term corrosion protection of pipeline joints, the technology and advantages achieved in the use of the invention present an almost limitless number of possible applications. Therefore, it is not the inventor's intent to limit the inventions use or application including those which are conducted in a less demanding environment such as shop, factory, or controlled environments. Unique and novel in both function and design, the invention combines the method and use of a controlled UV light initiated coating with the method and use of functionally engineered thermoplastic. The invention claims a process whereby a specially formulated UV light initiated coating is applied as a primer or basecoat whereupon a compatible functionally engineered thermoplastic is applied as the topcoat to protect and/or shield a substrate of substantially non-combustible material from corrosion, erosion and/or abrasion. Examples of substantially non-combustible material are metal, steel, concrete, masonry fiber reinforced composites, plastics, thermoplastics, epoxy and similar thermosetting resins, and vinyl ester and similar thermosetting resins. Highly versatile, the invention as described herein allows for application to new and existing surfaces with near equal success through a wide range of environmental and service conditions. Applied as a system, the UV light initiated basecoat functions as both a superior chemical resistant corrosion barrier and as a compatible advanced bonding site for the thermoplastic topcoat. The engineered thermoplastic functions as a tough outer barrier or layer that can be engineered or designed to resist or perform in a variety of physical conditions or service environments. The benefits claimed by the applied system or process are rapid installation, limited sensitivity to environmental conditions, highly predictable and repeatable applied properties, advanced chemical and corrosion resistance, and superior multi-functional performance.

As previously discussed, the principle of UV curing is based upon the initiation of a chemical polymerization inside a liquid coating by using direct UV irradiation to create a catalyzed or cross-linked solid coating. The method incorporates the introduction of a photoinitiator into the coating formulation, whereby controlled exposure to a concentrated UV light initiates an almost instantaneous chain reaction. The present commonly practiced application or use of UV light initiated coatings involved a process in which the coating is applied in a thinner single finished film, where upon exposure to a designed UV light source, the coating is near instantaneously cured. The result is a hard, fully cured, functionally resistant film that is immediately available for handling or packaging. However, for the purpose of this invention, the coating is used as a basecoat in combination with a thermoplastic topcoat where the applied and initiated UV cured basecoat must be functionally compatible with the topcoat. In many cases, a hard fully cured coating may not facilitate acceptable adhesion or bond of a particular thermoplastic topcoat.

As a method to assist in the facilitation of topcoat bond, an independent functioning adhesion promoting additive or filler may be mixed into the primer formulation prior to application. Introduced in the form of a liquid or selected sized solid particle, the additive or filler is dispersed within the applied primer layer in a sufficient amount and form to react and/or flow upon application of the topcoat. The thermal energy or heat from the applied thermoplastic topcoat causes the additive to chemically react and/or thermally enter into an advanced adhesive state thereby enhancing the adhesion compatibility and bond between the primer layer and topcoat. Examples of liquid adhesion promoting additives are silanes, titanates and heat activated catalyzing epoxides. Examples of solid adhesion promoting additives are thermoplastic epoxies; heat activated catalyzing epoxides, hot melt adhesives and thermoplastic polyolefin's.

Another method is to control, slow down and/or retard the curing process of the basecoat for a period of time in order to facilitate acceptable topcoat adhesion. This may be achieved in several ways such as adjusting the type and amount of photoinitiator, limiting exposure time to the light, and/or adjusting the spectral output of the light. The surface of the retarded or semi-cured coating or basecoat is then by design chemically open for a determined period of time to receive and bond with the applied thermoplastic topcoat. This method may also include the addition of adhesion promoting additives as previously discussed.

An alternate method of retarding the curing process or extending the overcoat time is through the introduction of amines or similar functioning materials. These materials function to reduce the rate of catalytic reaction thereby creating a controlled and predictable rate of cure. As with the previous method, the basecoat is then by design chemically open for a determined period of time to receive and bond with the applied thermoplastic topcoat. This method may also include the addition of solid adhesion promoting additives as previously discussed.

A preferred method is to adjust the composition of the coating formulation to include a separate functioning resin and/or functional curing agent whereupon it is co-blended into the formulation to create a dual activated, phased, or co-curing method of cure. As an example of this method, the coating composition can be formulated to achieve a semi-solid or gelled state upon controlled exposure to the light where it will remain open in a highly adhesive state until application of the thermoplastic topcoat. Upon application of the topcoat, the formulation is thermally promoted and/or activated by exposure to the heat from the applied thermoplastic topcoat to complete the curing process. It should be noted that a direct chemical interaction between the curing mechanisms can be created where the activation and/or initiation of one phase assists and positively effects the activation of the other phase. This type of compatible interaction optimizes overall system performance.

By definition, thermoplastic means the ability to move in and out of a molten state under the influence of heat and pressure. Practically, it is the ability to design and manufacturer a functional plastic polymer with specific performance properties, where by heat melting and forming or spray depositing the molten polymer onto a defined surface, a highly functional film or protective barrier can be created. Depending upon the identified performance requirements of a particular project, thermoplastic polymers can be formulated to contend with a wide range of service conditions. However, given that all materials or polymers have inherent functional limitations, a multiple number of functionally different thermoplastic polymer types must be available for consideration. Examples of a few types of thermoplastic polymers that are currently available for consideration are: Polyethylene, Polypropylene, Thermoplastic Elastomers, Nylon, Thermoplastic Epoxides, Thermoplastic Urethanes and Thermoplastic Polyesters. A thermoplastic polymer has certain inherent chemical characteristics and/or properties. Though most polymers can be modified with other functional materials to provide enhanced performance properties, every polymer has its range in which it can be modified before it becomes no longer practical or functional. Factors that may dictate the use of one thermoplastic polymer over another as they relate to the intended service application are thermal stability, dimensional stability, melt properties, flow properties, specific gravity, hardness, elongation, tensile strength, abrasion resistance, chemical resistance, temperature resistance, permeation resistance, insulation and/or conductive properties, flexural strength, material cost, processing cost, additive compatibility, adhesive properties, ease of application, service life, reparability, etc.

As previously discussed, a thermoplastic polymer has certain inherent and individual functional capability and properties. Depending upon chemical structure, flow properties, etc of the topcoat, the adhesive properties of the basecoat may require adjustment, as explained herein, in order to facilitate acceptable or functional topcoat bond. As expressed above, thermoplastics are defined by their ability to move in and out of a molten state under the influence of heat and pressure. Primarily influenced by heat, thermoplastics require no catalytic agents or solidification additives when placed into a molten or liquid application state in order to achieve their functional properties. Upon completion of application, they require only to cool back into their solid state or form in order to be ready for service. Therefore, thermoplastics are far less effected by conditions that can effect their performance properties such as humidity, temperature, mixing errors, pot life, re-coat and/or cure times, etc.

In the case of protecting pipeline joints, the application of the invention can be performed in a highly efficient, effective, and safe manner where the process and application of the entire protective coating system can be completed in a reasonably acceptable short period of time. The application as a corrosion protection system onto pipeline joints commonly but not exclusively occurs during installation of a new pipeline that is intended to transport or convey materials primarily in liquid form from one point to another. A pipeline is constructed by placing specified lengths or sections of pipe at or into a designated or prepared location where the pipe lengths are placed or aligned end to end. Constructed primarily of steel, the length of each section is primarily determined by the thickness and/or diameter of the pipe. The diameter of the pipe is primarily determined by the volume of material to be conveyed. Other factors such as placement conditions, location, line operating temperature, etc. also are taken into account. The primarily method of corrosion protection is to apply the protective coating system onto the pipe at the mill, factory, or in transit to the site at a given shop location. The protective coating system is held back or not applied to a given distance on each end of the pipe. The coated pipe sections are placed or aligned end to end where they are welded together to form a continuous transmission line. The length of the pipeline or number of welded sections determines the number of weld joints to be coated. The factory or shop applied protective coating is held back on the ends to facilitate the welding process which must occur on bare uncoated steel. The length of hold back or uncoated area is normally between 6″ and 12″ depending upon pipe thickness and pipe diameter. The extreme heat generated by the welding process can damage, burn, or dis-bond the coating if it is applied to close to the weld area.

The process of applying the invention to the welded joint occurs in several steps. First, the bare steel areas are sandblasted or otherwise prepared to a near white or white metal condition. Metal preparation or cleaning standards such as the Steel Structures Painting Councils standard SSPC-SP10 Near White to SSPC-SP5 White Metal are referenced. Other standards that specify or reference similar or equal preparation conditions such as those established by the National Association of Corrosion Engineers or NACE may also be employed. During the surface preparation procedure, a light sweep blast or approved equal cleaning to approximately 3″ to 4″ of the adjoining or adjacent coated surface is conducted to remove any surface contaminates. The adjacent coating should visually appear clean and slightly etched from the cleaning process. Second, upon completion of the surface preparation, a uniform resinous liquid film of UV light initiated primer or basecoat is applied by brush, roll, or spray as the primer or basecoat onto the prepared metal surface. The coating is not normally but may also be applied in the same manner and thickness onto the adjacent existing and prepared shop applied coating. Normally, the primer or basecoat is easily applied by brush, roll, or spray to a thickness of approximately 8 to 10 mils. It should be noted that depending upon the service requirements, the primer or basecoat may be applied at a thickness from 2 to 25 mils. Depending upon environmental conditions, choice of light source, installation requirements, service conditions, type or method of internal line corrosion protection system, support equipment, type of thermoplastic topcoat, etc., several versions or formulas of UV light initiated primer are available. As an example, a formulation of a UV light initiated coating that would use as a primer or basecoat in the method herein discussed is:

| | General | |
|---|---|---|
| | Formulation | Preferred |
| Cycloaliphatic Epoxy Resin - ERL 4221 by | 40% to 60% | 41% |
| Dow Chemical | | |
| Bisphenol A Epoxy Resin - #828 by Shell | 30% to 50% | 41% |
| Chemical | | |
| Polycaprolactam Polyol - Dow Tone 0301 by | 8% to 15% | 13.5% |
| Dow Chemical | | |
| Photoinitiator - Intimate #6990 by Dow | 2% to 5% | 3% |
| Chemical | | |
| Wetting Agent - BYK 333 by BYK Chemie | .5% to 3% | 1.5% |
| Total - | 100% | 100% |

As previously discussed, in order to initiate a partial cure, cure or initiate a predetermined rate of cross-linking reaction within the UV light initiated coating, the use of an appropriate UV light source is required. For the majority of UV light initiated applications, a light source that emits UV light wavelength in the range of 325 nm to 450 nm is preferred. However, wider or narrower light wavelengths may be considered depending upon the function and type of photoinitiator. In the case of pipeline joints and depending upon the type and intensity of the light source utilized or depending upon the diameter of the joint, a carriage or conveyance mechanism that rotates the light around the coated joint surface at a predetermined distance and speed may be used. Alternately, a mechanism that places a series of lights at a predetermined distance that facilitates light exposure or initiation to the entire target surface at the same time may be used.

Depending upon the intensity of the light, spectral range and output of the light source and formulation of the basecoat/primer, the time or rate of light exposure may be varied. Depending upon environmental conditions, type and amount of initiator used, installation requirements, service conditions, designed or required thickness of the applied coating, available support equipment, pipe diameter, type of thermoplastic topcoat, etc., several versions and/or types of UV light sources could be utilized. As an example, the Fusion UV Systems, Inc. Model F300S using a Model P300MT Power Supply with a “D” type spectral bulb at 300 watt/inch could be used when higher exposure or intensity is required. Alternately, a BLB type of UV light source such as the FL20BLB supplied by Eye Lighting International/Iwasaki Electric Co. could be used when lower exposure or intensity is sufficient.

Upon completion of the primer or basecoat application process, the thermoplastic topcoat is applied in a single uniform coat. A preferred method of application is flame spraying. The thermoplastic topcoat is supplied from the factory in a graded powder form. Using a Powder Master Flame Spray Unit as manufactured by PFS/lnnotek Inc. or other approved type, a generally uniform stream of powder is blown through a regulated and controlled flame comprising of a mixture of compressed air and propane. As the powder stream passes through the flame, the heat generated by the flame turns the plastic powder molten. The powder is propelled through the flame with sufficient regulated velocity and form that it is deposited onto the surface in a controlled uniform manner. Upon contact with the target surface, the physical dynamic of the application process causes the formulated or engineered thermoplastic to wet out, flow, and bond thereby creating the functional protective outer layer or topcoat. Depending upon the type of polymer, the sieve or particle size of the powder, service requirements, etc., the thermoplastic topcoat can be applied anywhere from 10 to 150 mils in a single flame spray application process. As an example, a formulation of an engineered polypropylene that would be used in a pipeline application could be:

| | General Formulation | Preferred |
|---|---|---|
| Polypropylene Resin - | 50% to 80% by wt. | 70% by wt. |
| Orevac 18732 by Atofina | | |
| Polypropylene Resin - | 20% to 50% by wt. | 20% by wt. |
| Finaplas 1751 by Atofina | | |
| Heat Stabilizer - | 2% to 4% by wt. | 3.5% by wt. |
| BNX 1010 by Mayzo, Inc. | | |
| Secondary Stabilizer - | −1.5% to 3% by wt. | 1.5% by wt. |
| BLS 1680 by Mayzo, Inc. | | |
| Light Stabilizer - | 2% to 4% by wt. | 3% by wt. |
| BLS 1770 by Mayzo, Inc | | |
| Titanium Dioxide - | 1% to 5% by wt. | 2% by wt. |
| Ti02 by Dupont | | |
| Total | 100% | 100% |

It is important to note that in the above formulation two different functioning polypropylene resins are blended or processed together. By combining their individual and compatible functional properties, a hybrid or engineered polypropylene thermoplastic coating with specific performance properties is created. In this case, the properties of toughness, adhesion, melt flow, creep resistance and permeation found in the Orevac 18732 are matched or blended with the properties of flexural strength, dimensional stability, melt flow, and process ability found in the Finaplas 1751. The choice of stabilizers and other functional additives is determined by the physical and functional properties of the combined polypropylene resins and as they relate to the application process and service environment. Advanced manufacturing and processing equipment allow for the combination of a wide variety of chemically compatible thermoplastic resins. Given specific performance and/or functional requirements of a particular application, the physical and/or chemical properties of a specific resin can be mixed, blended or processed with another compatible resin to create a series of functional hybrids. In addition, functional mineral and/or chemical fillers or additives may also be blended, added or manufactured into a particular topcoat resin, formulation or compound to provide alternate or additional performance capability. Examples are glass beads or ceramic to enhance abrasion resistance, treated mica or glass to enhance permeation resistance and heat catalyzed or similar thermosetting materials to enhance toughness. Other examples of properties that fillers or additives can provide are static dissipation, flame retardance, conductivity, bio-stabilization, anti-fouling, non-stick, color, etc. Examples of alternate methods in which the thermoplastic topcoat can be applied are pre-melting the thermoplastic and applying via molten spray or via wiper extruder or pre-manufacture the thermoplastic in sheet form where it can be wrapped around the joint or placed onto the primer and heated via flame or alternate heat source to a molten or semi-molten state. Unique and novel in both function and design, this invention teaches that by combining the method and functional use of a controlled UV light initiated coating with the method and use of functionally engineered thermoplastic, a highly useful method and process as explained herein is created.

### INDUSTRIAL APPLICABILITY

The present invention may be used in any industry that could benefit from using a simple, reliable, easily applied apparatus and method for protecting, maintaining, repairing, refinishing, refurbishing and/or replacing a substrate that is exposed to corrosion, abrasion, erosion, chemical attack, environmental weathering, electrical disbandment, abrasion, impact and other detrimental forms and effects experienced in an industrial or otherwise applicable environment.

Though the present invention is primarily intended to protect oil and gas pipeline joints, it could be used as a protection barrier in a variety of applications such a tank linings, structural steel, pipe lining, secondary containment, and pipeline line coatings. Examples of applicable environments are saltwater, waste water, electrical, chemical, radiological, toxic and atmospheric. Other applications for the apparatus of this invention can be easily found.

The present invention can be applied to a wide variety of different substrates. For example, this invention could be applied to a substrate comprising metal, steel, concrete, ceramics, masonry, fiber reinforced composites, plastics, thermoplastics, epoxy and similar thermosetting resins, vinyl ester and similar thermosetting resins or nearly any other material that is generally non-flammable.

1. A process for protecting and/or shielding a substrate of substantially non-combustible material from corrosion, erosion and/or abrasion, said process comprising the steps of:
(a) cleaning the substrate;
(b) applying a UV light initiated basecoat to the substrate, said basecoat changing to a semi-fluid, gelled or solid state when exposed to the UV light, said basecoat adhering or bonding to the substrate;
(c) exposing said basecoat to UV light to initiate crosslinking and polymerization of components of said substrate;
(d) applying a thermoplastic topcoat to said basecoat, said topcoat adhering or bonding to said basecoat, said basecoat forming a secure, functionally stable and compatible anticorrosive foundation for said topcoat, said topcoat forming a bonded layer over said basecoat, said topcoat protecting said basecoat from chemical, ultraviolet or mechanical attack.

2. The process of claim 1, wherein said basecoat becomes semi-fluid, gelled or solid when exposed to a controlled UV light source emitting light primarily concentrated in the wavelength range of 325 nm to 450 nm, said basecoat having compatible adhesive properties with said topcoat.

3. The process of claim 1, wherein said basecoat is applied to the substrate in a fluid state.

4. The process of claim 1, wherein an independent functioning adhesion promoting additive or filler is mixed into said basecoat.

5. The process of claim 1, wherein the amount and type of photoinitiator is adjusted within the basecoat formulation to control, slow down and/or retard the curing process.

6. The process of claim 1, wherein adjusting the UV light source in intensity, distance, time and/or spectral output to control, slow down and/or retard the basecoat curing process.

7. The process of claim 1, wherein an additive or compound is mixed into the basecoat to control or reduce the rate of catalytic reaction or rate of cure.

8. The process of claim 1, wherein a separate functioning resin and/or functional curing agent is co-blended into the formulation to create a dual activated, phased, or co-curing method of cure.

9. The process of claim I, wherein said basecoat has a thickness of about 2 mils to 25 mils.

10. The process of claim 1, wherein the substrate is of substantially non-combustible and/or thermally stable materials such as metal, steel, concrete, ceramics, masonry, fiber reinforced composites, plastics, thermoplastics, epoxy and similar thermosetting resins, and vinyl ester and similar thermosetting resins.

11. The process of claim 1, wherein said topcoat is applied by method of flame spray, molten spray, or heat forming.

12. The process of claim 1, wherein said topcoat can be compounded and/or formulated to provide and/or operate in a wide range of service requirements and/or conditions.

13. The process of claim 1, wherein said topcoat comprises a thickness of about 10 mils to 150 mils.

14. The product produced by the process of claim 1.

15. The product produced by the process of claim 2.

16. The product produced by the process of claim 11.

17. A pipeline joint protected from corrosion by a coating system applied over a weld joining adjacent pipeline sections, said pipeline joint formed by the steps of:
(a) welding adjacent sections of said pipeline together to form a weld zone;
(b) cleaning said weld zone;
(c) applying a UV light initiated basecoat to the substrate, said basecoat changing to a semi-fluid, gelled or solid state when exposed to the UV light, said basecoat adhering or bonding to the substrate;
(d) exposing said basecoat to UV light to initiate crosslinking and polymerization of components of said substrate; and
(e) applying a thermoplastic topcoat to said basecoat, said topcoat adhering or bonding to said basecoat, said basecoat forming a secure, functionally stable and compatible anticorrosive foundation for said topcoat, said topcoat forming a bonded layer over said basecoat, said topcoat protecting said basecoat from chemical, ultraviolet or mechanical attack.

18. The pipeline joint of claim 17, wherein said basecoat is exposed to UV light in the wavelength range of 325 to 450 mils.

19. The pipeline joint of claim 17, wherein said basecoat has a thickness of about 2 to 25 mils.

20. The pipeline joint of claim 17, wherein said topcoat is applied by flame spraying.

21. The pipeline joint of claim 17, wherein said topcoat has a thickness of about 10 to 150 mils.
